(19) United States
(12) Patent Application Publication
(10) Pub. No.: US 2017/0075011 A1
(43) Pub. Date: Mar. 16, 2017

(54) METHOD AND DEVICE FOR CONTROLLING SOURCE SUBARRAYS ARRANGEMENT

(71) Applicant: CGG SERVICES SA, Massy Cedex (FR)

(72) Inventors: Yuan NI, Paris (FR); Thomas MENSCH, Paris (FR)

(73) Assignee: CGG Services SA, Massy Cedex (FR)

(21) Appl. No.: 15/123,337

(22) PCT Filed: Mar. 13, 2015
(86) PCT No.: PCT/IB2015/000998

§ 371 Date: Sep. 2, 2016

Related U.S. Application Data
(60) Provisional application No. 61/952,912, filed on Mar. 14, 2014.

(51) Int. Cl. G01V 1/38

(52) U.S. Cl. CPC G01V 1/3826; G01V 1/3861; G01V 1/3808

(57) ABSTRACT

The arrangement of air-gun subarrays is controlled by adjusting a geometric parameter, such as, an inline distance, an attack angle and/or a cross-line position for one or more subarrays. The adjustment is performed to achieve a target energy distribution for signals emitted by the air-gun subarrays.

### CROSS REFERENCE TO RELATED APPLICATIONS

This application claims priority and benefit from U.S. Provisional Patent Application No. 61/952,912, filed Mar. 14, 2014, for “Dynamic control of the source subarray position for air-gun array directivity optimization and other advantages,” the content of which is incorporated in its entirety herein by reference.

### BACKGROUND

Technical Field

Embodiments of the subject matter disclosed herein generally relate to controlling geometry of a marine seismic source during a survey or, more specifically, to adjusting a two-dimensional (2D) arrangement of the marine seismic source's subarrays in the water surface plane.

Discussion of the Background

The structure of underground formation is often explored using reflection seismology. In reflection seismology, a source or energy emits signals (which can be expressed as overlapping seismic waves) directed at the explored formation. Reflections of the signals arrive at different time intervals after the signal emissions at receivers. The reflections occur at interfaces between the explored formation's layers because signal propagation speed changes at these interfaces. The reflections carry information allowing estimation of depths of the interfaces and the nature of the layers. An image of the underground formation generated using this information may suggest the presence of subterranean hydrocarbon deposits. Reflection seismology is used on land and in marine environments.

A traditional marine survey system 100 for generating seismic signals and recording their reflections off a formation under the seafloor is illustrated in FIG. 1. A vessel 110 tows an array of seismic receivers 111 provided on streamers 112 (only one shown). The streamers may be towed so that the receivers are at a substantially constant depth relative to a surface 114 of the water. However, the streamers may alternatively be towed so that receivers 111 on a same streamer 112 are at different depths from the surface 114.

Vessel 110 also tows a seismic source 116 configured to generate seismic signals directed at the explored formation. The signals propagate along various trajectories 118 (only one labeled). Since the seismic signals are directed toward the explored formation, their energy propagates preferably downward, toward the seafloor 120. The seismic signals penetrate seafloor 120 into the explored formation, being reflected, for example, at an interface 122. The reflected signals propagate upward, along trajectories such as 124, and are detected by receivers 111 on streamer 112. Analysis of the data (e.g., arrival time and amplitude of the reflected signals) collected by the receivers 111 may yield an image of the formation under the seafloor.

Recently, marine survey systems include plural vessels, some of which tow sources on trajectories parallel to the trajectory of a vessel towing streamers (as described, for example, in U.S. Pat. No. 8,873,332 and U.S. Patent Application Publication No. 2013/0170316, the entire contents of which are incorporated in their entirety herein by reference). The use of additional sources increases azimuth diversity in the collected data.

Traditionally, in the water surface plane, the marine sources emit maximum energy in a direction R opposite to the towing direction T as illustrated in FIG. 2. FIG. 2 is a snapshot of the emitted energy, where the gray hues correspond to energy density (darker hues correspond to larger energy density). The azimuth angle varies around the circle (180° corresponding to the towing direction). Radii of the circles illustrate distance from the emission point, which is in the middle of this circular diagram. FIG. 3 is a Rose diagram illustrating offset/azimuth distribution of the detected reflections for a conventional marine survey system: a vessel towing 10 streamers with 100 m separation between streamers and a streamer length of 9300 m (10×100 m×9300 m), radii of a circle corresponding to the same distance (offset) from the source to the detection point, and the sector bins correspond to different azimuth angle ranges as marked on the edge of this diagram. The nuances of gray correspond to a number of the detected signals, the whiter the nuance the more detected reflections.

In marine survey systems including vessels towing conventional sources laterally relative to the receivers, the receivers record fewer reflections of the signals emitted by lateral sources (i.e., sources towed lateral relative to the streamer, being towed by a vessel other than the one towing the streamers). This less-than-optimal situation occurs because, in the water surface plane, the greatest amount of energy is emitted in a direction opposite from the towing direction and not toward the streamers carrying the receivers.

Additionally, as discussed in the article, “High-frequency signals from air-gun arrays,” by M. Landro et al., published in Geophysics, vol. 76, No. 4, July-August 2011, pp Q19-Q27 (the content of which is incorporated in its entirety herein by reference), it is desirable to attenuate high-frequency (over 1 kHz) components of signals emitted by air-gun array sources because these high-frequency components negatively impact aquatic animals without being actually useful for the survey.

Accordingly, it is desirable to develop methods and sources able to optimize detection when sources are towed laterally relative to streamers and/or attenuate high-frequency components.

### SUMMARY

Geometry of a marine source including plural air-gun subarrays refers to the 2D arrangement of the subarrays in the water surface plane and individual depths of the subarrays or air-guns, and determines the emitted energy distribution. The arrangement is defined based on air-gun subarrays' individual inline distances, attack angles and cross-line positions. Controlling these parameters allows controlling the emitted energy distribution.

According to an embodiment, there is a method for controlling geometry of towed air-gun subarrays. The method includes deploying the air-gun subarrays in water. Each of the air-gun subarrays has air-guns attached substantially along a longitudinal segment linked to a towing vessel via an umbilical cable. The method further includes adjusting a geometric parameter for at least one of the air-gun subarrays, to change energy distribution of seismic signals generated by the subarrays.

According to another embodiment, there is a marine seismic source configured to emit seismic signals. The source includes air-gun subarrays, each of the air-gun subarrays having air-guns attached substantially along a longitudinal segment linked to a towing vessel via an umbilical cable. The source also includes a controller configured to control the air-gun subarrays by changing a geometric parameter of at least one of the air-gun subarrays.

According to yet another embodiment, there is a seismic survey system including a towing vessel, one or more streamer carrying receivers, a marine seismic source and a controller. The marine seismic source includes air-gun subarrays, each of the air-gun subarrays having air-guns attached substantially along a longitudinal segment linked to the towing vessel via an umbilical cable. The controller is configured to control geometry of the marine seismic source by changing a geometric parameter for at least one of the air-gun subarrays.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a traditional marine survey system;

FIG. 2 is diagram illustrating spatial distribution of the energy emitted by a conventional source;

FIG. 3 is a Rose diagram corresponding to the offset azimuth distribution for a conventional 3D acquisition geometry;

FIG. 4 is a marine source according to an embodiment;

FIG. 5 illustrates an air-gun subarray;

FIG. 6A and 6B illustrate two subarray arrangements for a marine source according to another embodiment;

FIG. 7 is diagram illustrating spatial distribution of the energy emitted by the source, when the subarrays are arranged as in FIG. 6B;

FIG. 8 is a Rose diagram corresponding to the offset/azimuth distribution for a multi-vessel acquisition geometry;

FIGS. 9A and 9B illustrate change of a subarray's attack angle according to an embodiment;

FIG. 10 illustrates change of a subarray's cross-line position according to an embodiment;

FIG. 11 illustrates change of a subarray's cross-line position according to another embodiment;

FIG. 12 is a flowchart of a method according to an embodiment;

FIGS. 13A and 13B illustrate different subarray arrangements according to an embodiment;

FIGS. 14A and 14B are graphs for high frequency noise level emitted by the subarrays arranged as in FIGS. 13A and 13B, respectively;

FIG. 15 is a schematic diagram of a controller according to an embodiment; and

FIG. 16 illustrates a marine seismic survey system according to an embodiment.

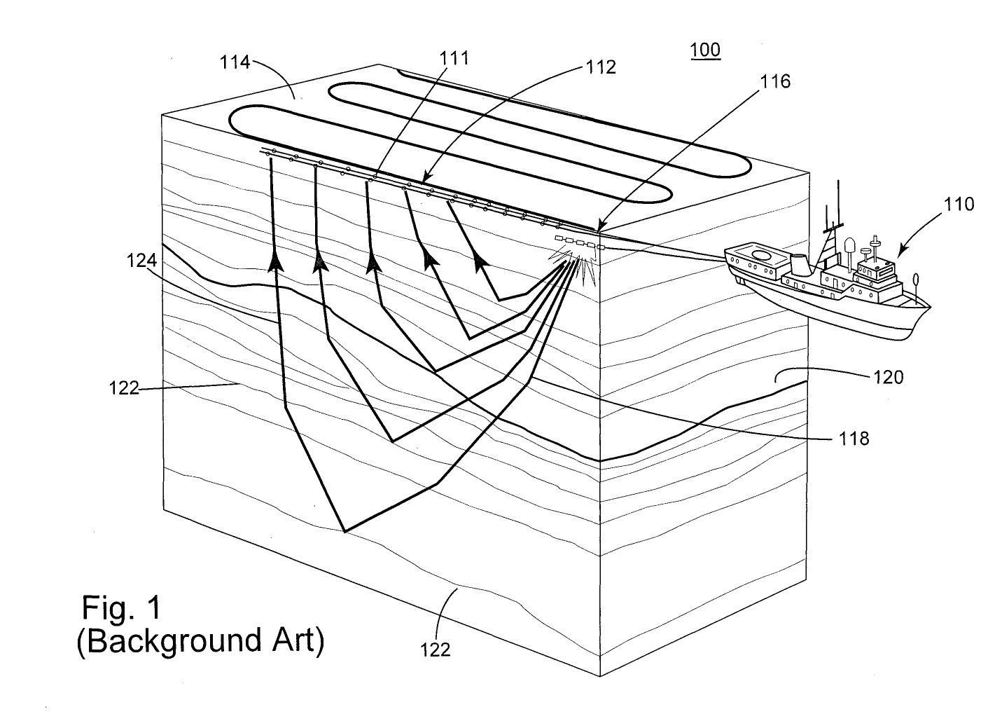

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, relative to a marine source including plural air-gun subarrays. However, similar methods and devices may be used for other marine sources and for sources emitting electromagnetic signals.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

In order to detect more energy reflected from an explored formation under the seafloor, and/or to protect the marine animals by attenuating the high frequency components of seismic signals, geometry of air-gun subarrays of a marine source is controlled/adjusted. The air-gun subarrays may be arranged in the water surface plane so that more energy to be emitted in a predetermined direction (the projection of this predetermined direction in the water surface plane pointing toward the receivers). In the conventional arrangement the air-gun subarrays are towed at a substantially same inline distance, a null attack angle (i.e., parallel to the towing direction) and at predetermined cross-line positions, arrangement which typically does not change throughout the survey. In contrast, according to various embodiments, an air-gun subarray's inline distance, cross-line position or attack angle is adjusted to change emitted energy distribution of the signals.

Although, in this document, the focus is on a two-dimensional subarray arrangement in a horizontal (water surface) plane, depths of the individual sources and of the subarrays are also parameters that may vary. Depths of individual sources and subarrays may be optimized when the gun firing sequence is designed to achieve a target far-field signal. However, a multi-dimensional and multi-objective optimization may be performed for all the parameters defining the marine source's geometry.

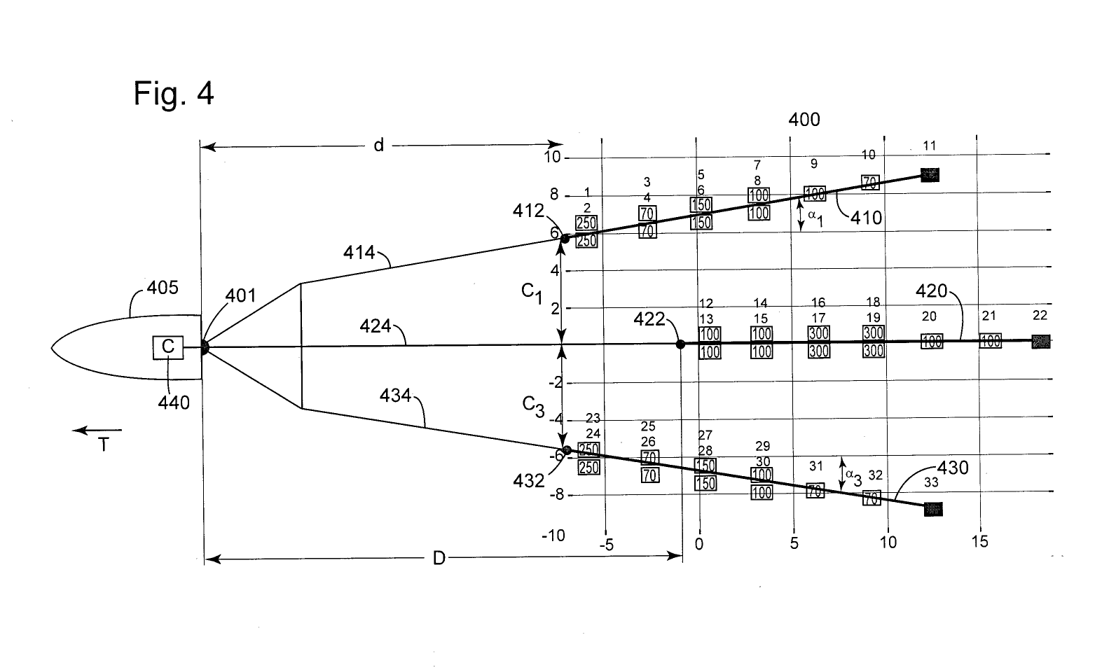

FIG. 4 is a bird's eye view of a marine source 400 according to an embodiment. Source 400 is towed by a vessel 405 moving in towing direction T. Source 400 includes three subarrays 410, 420 and 430. For each of the subarrays, the air-guns (small rectangles in FIG. 4) are attached along a longitudinal segment, whose front end (i.e., 412, 422 or 432) is connected to vessel 405 via an umbilical cable (i.e., 414, 424, and 434, respectively). The number of subarrays and air-guns is merely illustrative and is not intended to be limiting.

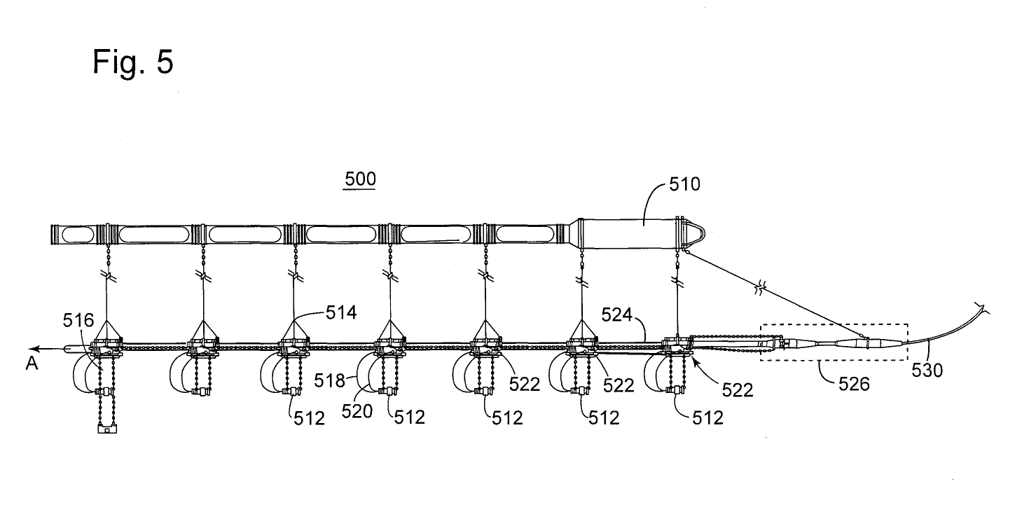

FIG. 5 illustrates a front portion of an air-gun subarray 500 (which may be any one of the subarrays 410, 420 or 430) according to one embodiment. Subarray 500 includes a float 510 from which air-guns 512 (not all labeled) are suspended with cables or ropes such as 514. In some locations, such as 516, two or more air-guns may be attached one under another (as illustrated) or parallel, at the same depth. The air-guns may have different volumes (e.g., in a range of 50-350 cm³), and they are fired to combine into a signal (i.e., pressure wave propagating at sound speed). Some of the air-guns (e.g., filled with black in FIG. 4) may be turned off deliberately or due to malfunction.

An umbilical cable 530 connects subarray 500 to the vessel (not shown, but similar, for example, to umbilical cable 414 connecting subarray 410 to vessel 405 in FIG. 4). Umbilical cable 530 may include cables providing electric power, compressed air, data transmission, etc. Air-gun bases 522 (only some labeled) are connected to each other via links such as 524. The electric power, compressed air and data are distributed to (or collected from) the air-guns via these links. For example, a link 518 supplies the compressed air, and a link 520 provides electric power and/or data transmission to/from air-gun 512.

Float 510, cable and ropes such as 514, and the links such as 524 form a support structure for the air-guns. A front end 526 of this support structure may be a bell house inside which individual links combine. Front end 526 may also include a bend restrictor to which the float is attached. A longitudinal segment along which the air-guns are attached may be defined by the support structure or as merely a segment between a first and a last air-gun aligning in the towing direction.

When air-guns 512 are fired, bubbles they produce coalesce to produce a relatively large broadband signal. Traditionally, the air-guns are optimized (i.e., their volumes, depths, positions along the longitudinal segment, and firing sequence) focusing on the low-frequency (e.g., 10-100 Hz) components of this far-field signal, which are more likely to penetrate deep into the explored formation and be detected than the high-frequency components. Lately, the optimization also seeks attenuating high-frequency (e.g., over 1 kHz) components of signals to avoid disturbing aquatic animals. Landro, in the previously cited article, proposes achieving the desirable attenuation of high-frequency components by increasing the areal extent of the gun array. Some of the marine source embodiments achieve this objective, in parallel to controlling the energy distribution for the emitted signals, by tuning inline distance, cross-line position or attack angle of one or more air-gun subarrays.

Returning now to FIG. 4, an inline distance of a subarray may be defined as a distance from the front end of the subarray to the towing vessel, in the towing direction T. A same line perpendicular to towing direction T (e.g., a line passing through point 401 where the umbilical cables are attached) is used to evaluate the inline distances for all the subarrays. In FIG. 4, subarrays 410 and 430 have a same inline distance d, while subarray 420 has an inline distance of D>d.

A subarray's attack angle is the angle between the subarray's longitudinal segment and the towing direction. In FIG. 4, subarray 410 makes a non-zero angle α₁ counterclockwise relative to the towing direction in the water surface plane. Subarray 430 makes a non-zero angle a₃ clockwise relative to the towing direction in the water surface plane. Angles α₁ and α₃ may be equal, but the symmetric subarray arrangement in FIG. 4 is merely an illustration and not intended to be limiting.

A cross-line position of a subarray is defined as being a position on a line perpendicular to the towing direction in the water surface plane. The line used to define the subarray's cross-line position may be identified in the same manner for all subarrays. For example, as illustrated in FIG. 4, the line may pass through the subarray's front end. In another example, the line may pass through the subarray's middle. The null reference used for evaluating cross-line positions may be the vessel's trajectory. In FIG. 4, front end 422 of subarray 420 is on the vessel's trajectory and, thus, the cross-line position of subarray 420 is 0. Subarray 410 has a cross-line position c₁ on one side of the vessel's trajectory, and subarray 430 has a cross-line position c₃ on the other side thereof (e.g., c₁=8 m and c₃=−8 m).

A controller 440 may be located on vessel 405 and configured to control the air-gun subarrays while towed, to achieve the targeted subarray arrangement (e.g., so that the seismic signals have a maximum energy emitted in a predetermined direction). Thus, controller 440 causes one (or more) of the subarrays to change its inline distance, attack angle and/or cross-line position.

The inline distance, the attack angle and the cross-line position may be adjusted simultaneously or sequentially. For example, changing the cross-line position or the attack angle while the length of the umbilical cable remains the same also causes a change in the inline distance. In another example, a lateral force applied to a point other than the subarray's rotation center may cause a change both in the attack angle (a rotation) and cross-line distance of a subarray (a translation).

In some embodiments, the controller may adjust the inline distance by modifying the length of the umbilical cable. For example, the controller may cause rolling or unrolling the umbilical cable on or off a spool located on the towing vessel.

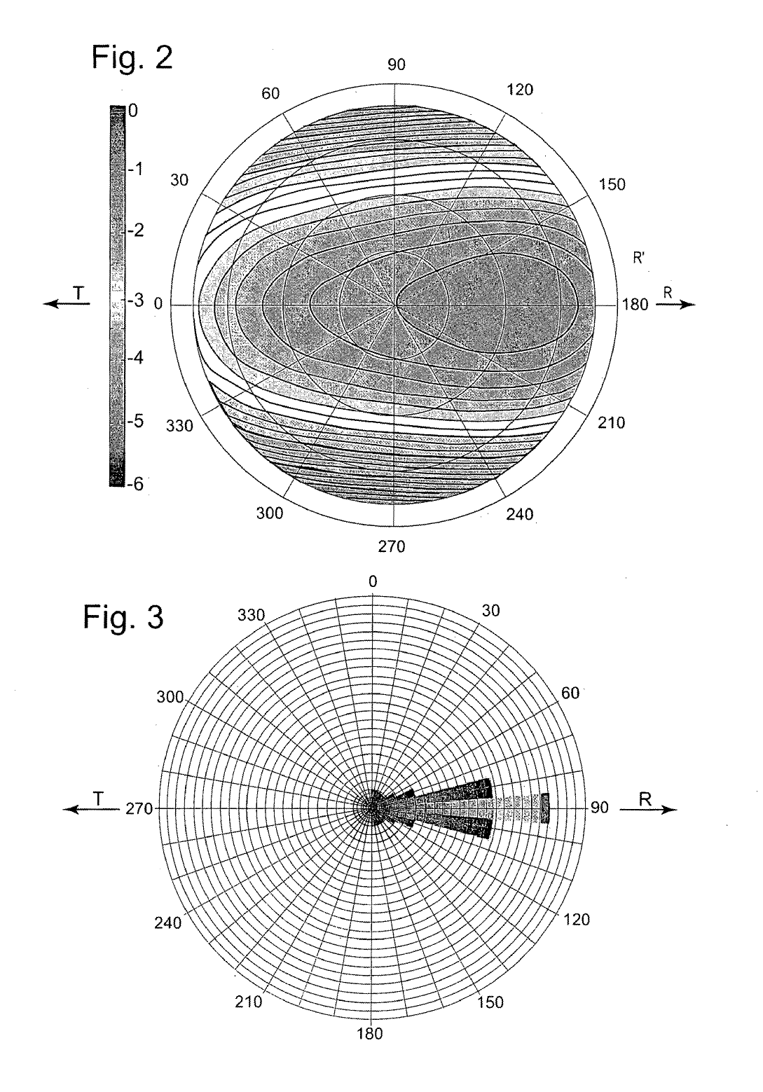

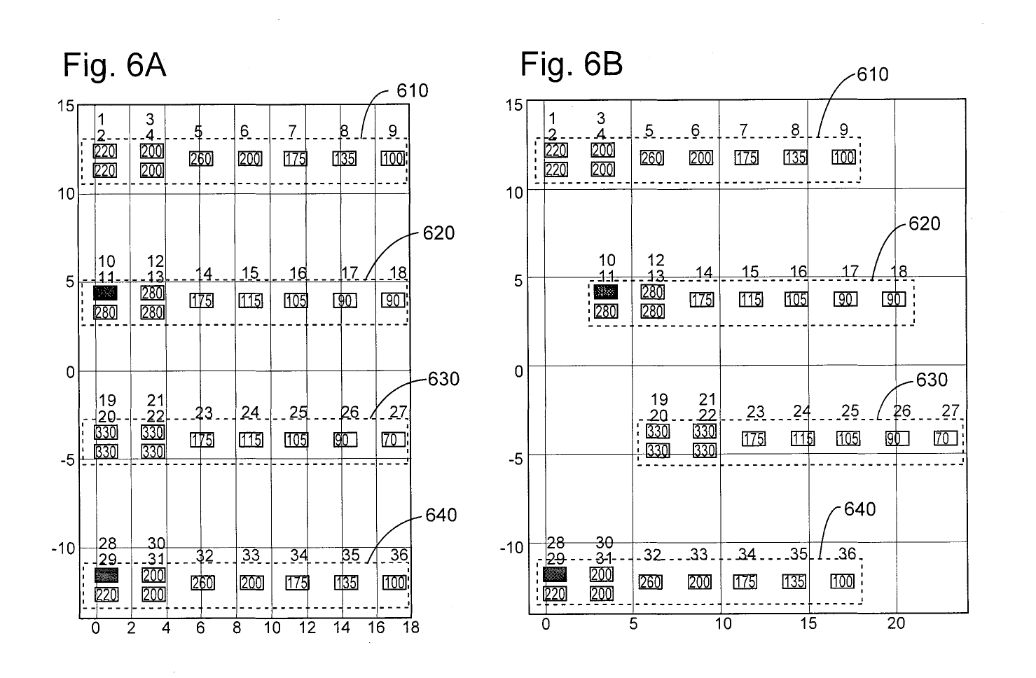

FIG. 6A is a conventional arrangement of a source 600 including four air-gun subarrays 610, 620, 630 and 640. According to the conventional arrangement, the air-gun subarrays have the same inline distance, being aligned perpendicular to towing direction T. Air-gun subarrays 610, 620, 630 and 640 also have zero attack angles (i.e., are arranged substantially parallel to the towing direction), and 12 m, 4 m, −4 m and −12 m cross-line positions, respectively. The energy distribution and Rose diagram for this arrangement are illustrated in FIGS. 2 and 3.

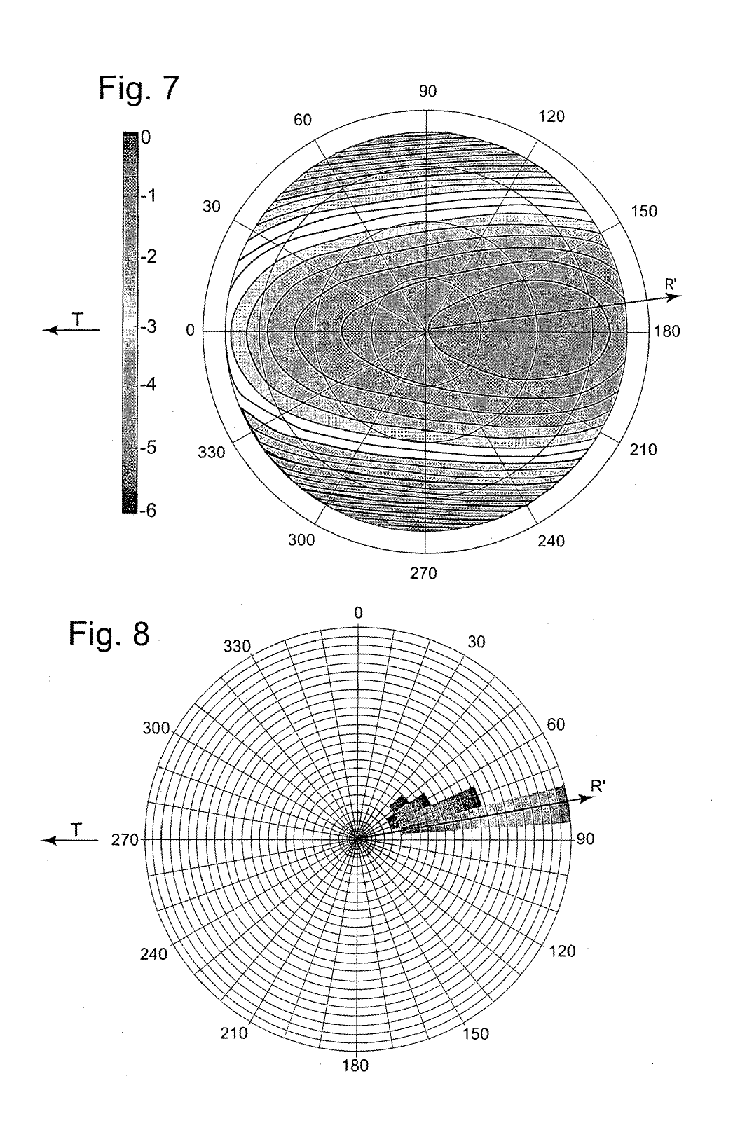

FIG. 6B is an arrangement of a source 600 according to an embodiment. Air-gun subarrays 610 and 640 have the same inline distances. Air-gun subarray 620 has an inline distance 6 m longer than subarray 610 and 640′s inline distance, and air-gun subarray 630 has an inline distance 12 m longer than subarray 610 and 640′s inline distance. Air-gun subarrays 610, 620, 630 and 640 have zero attack angles and the same cross-line positions as in FIG. 6A. The energy density distribution in the water surface plane is illustrated in FIG. 7. FIG. 7 shows that more energy is emitted around direction R′, away from 0° (at about 8° azimuth angle). FIG. 8 shows an offset/azimuth distribution for a multi-vessel arrangement, where the seismic source is towed by an independent vessel sailing 1000 m aside the streamer vessel (as illustrated in FIG. 16, with source 1650 deactivated, only source 1620 is fired). When compared to FIG. 3, it results in a different subsurface illumination including an increase and a shift of the detected reflections away from 0° azimuth.

The controller may adjust the attack angle of a subarray by causing a momentum to rotate of the subarray, in the water surface plane. The controller may cause this momentum by increasing surface perpendicular to the towing direction of a deflector attached, for example, at the distal end of the subarray. In one embodiment, the subarray rotates around a center of mass thereof. However, if the subarray is subject to constraints (e.g., ropes limiting the range of the subarray's cross-line translation) the subarray may rotate around another center.

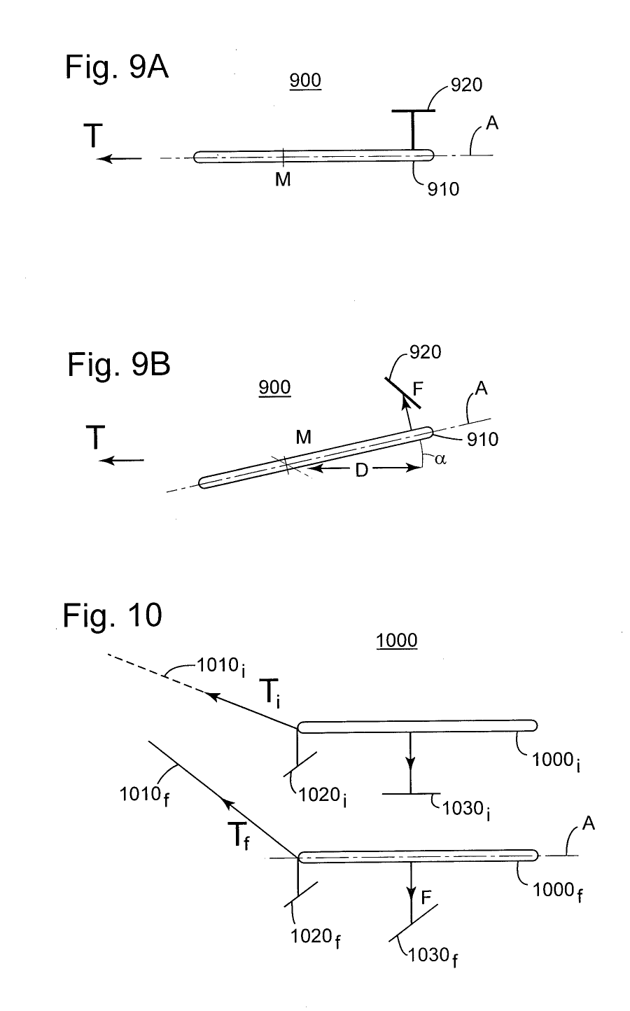

FIG. 9A illustrates an initial position of a subarray 900 able to rotate around its mass center M when deflector 920 generates a lateral force F at its distal end 910. The initial angle of attack is zero since subarray 900's longitudinal axis A and deflector 920 is aligned along the towing direction. FIG. 9B illustrates a final position of subarray 900. Deflector 920 is now oriented to generate a lateral force F rotating subarray 900 counterclockwise in the water surface plane. As subarray 900's surface perpendicular to the towing direction increases, its drag force D also increases. Drag force D creates a momentum opposite to the momentum generated by force F. The tension force in the umbilical cable connecting the subarray to the vessel may also change, and it creates a momentum also opposite to the momentum generated by force F. When the sum of the momenta acting on the subarray is zero, the subarray no longer rotates. In its final, equilibrium position, the subarray has a (non-zero) attack angle α different from its initial (zero) attack angle.

The controller may adjust the cross-line position of a subarray by causing a force perpendicular to the towing direction, the force translating the subarray in the water surface plane. FIG. 10 illustrates subarray 1000 connected to a vessel (not shown) via an umbilical cable 1010. Subarray 1000 is moved from an initial position illustrated with dashed lines (and indicated by index i) to a final position illustrated with continuous lines (and indicated by index f) due to a lateral force F. The lateral force may be generated by a deflector 1030 whose surface perpendicular to the towing direction is increased. In the initial position, the cross-line component of the initial tension Tᵢ is canceled by a force due to a deflector 1020, whose position does not change between initial and final states. In the final position, lateral force F is canceled by the increased tension T_{f} in umbilical cable 1010. In other words, the final cross-line component of tension T_{f} balances the forces due to both deflectors 1020 and 1030 (deflector 1030 generating the lateral force F).

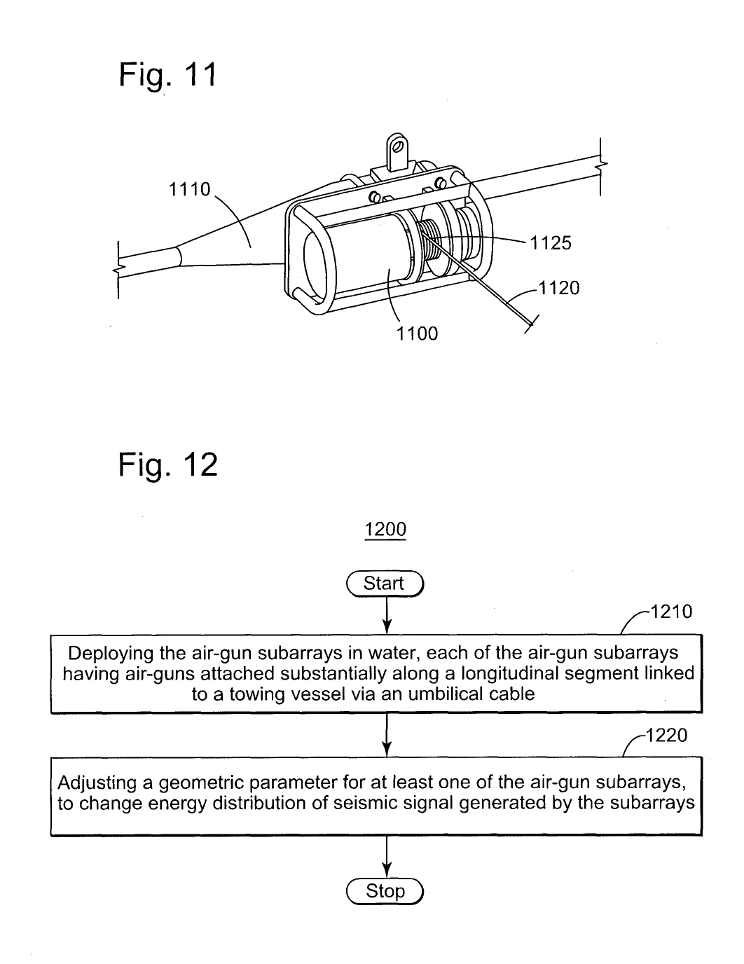

In another embodiment, the controller may change cross-line position of a subarray by causing a change of the length of ropes interconnected between umbilical cables of different subarrays or between an umbilical cable and a wide tow rope as described in U.S. Pat. No. 8,891,331 (the content of which is incorporated in its entirety herein by reference). FIG. 11 illustrates an actuator device 1100, attached to an umbilical 1110 and configured to change length of rope 1120 attached between umbilical 1110 and a wide tow rope (no shown). Actuator device 1100 may be controlled by the controller and may include a winch 1125.

FIG. 12 is a flowchart of a method 1200 according to an embodiment. Method 1200 aims to control geometry of towed air-gun subarrays. Method 1200 includes deploying the air-gun subarrays in water, at 1210. Each air-gun subarray has air-guns attached substantially along a longitudinal segment linked to a towing vessel via an umbilical cable. Method 1200 further includes adjusting a geometric parameter (e.g., an inline distance, an attack angle and/or a cross-line position for at least one of the air-gun subarrays), at 1220. The step of adjusting results in changing energy distribution of the seismic signals.

Adjusting step 1220 may be performed to achieve an arrangement of the air-gun subarrays that has been designed by simulation. Alternatively or additionally, adjusting step 1220 may be performed to achieve an arrangement of the air-gun subarrays that has been determined based on measurements of the seismic signals for different arrangements of the air-gun subarrays.

The arrangement of the air-gun subarrays may be designed or determined to direct a larger amount of energy toward receivers and/or to attenuate high-frequency components of the seismic signals. In other words, in addition to or instead of achieving the seismic signals' maximum energy emitted in the predetermined direction, the arrangement may also be optimized to attenuate the high-frequency (over 1 kHz) components of the seismic signals.

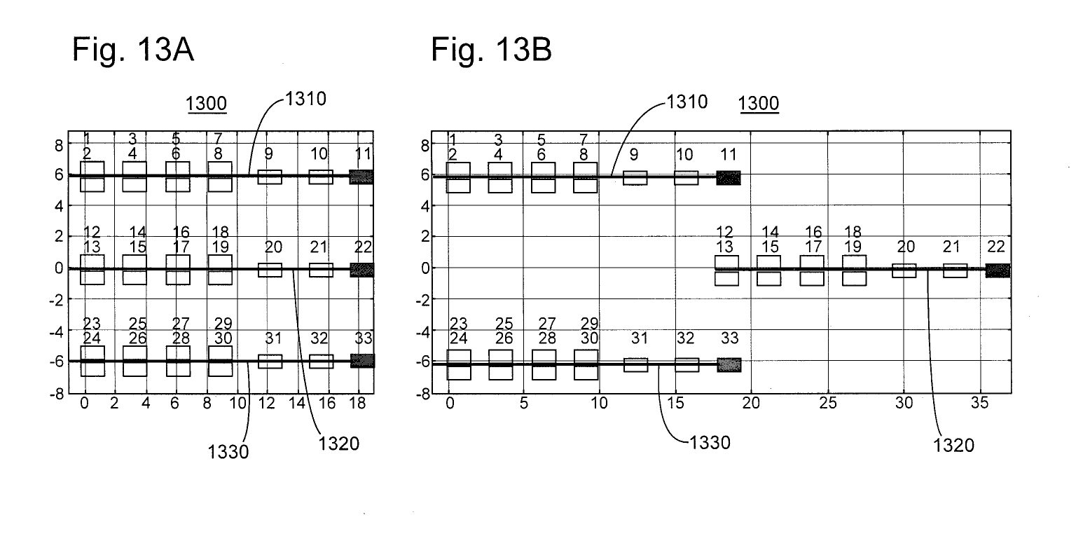

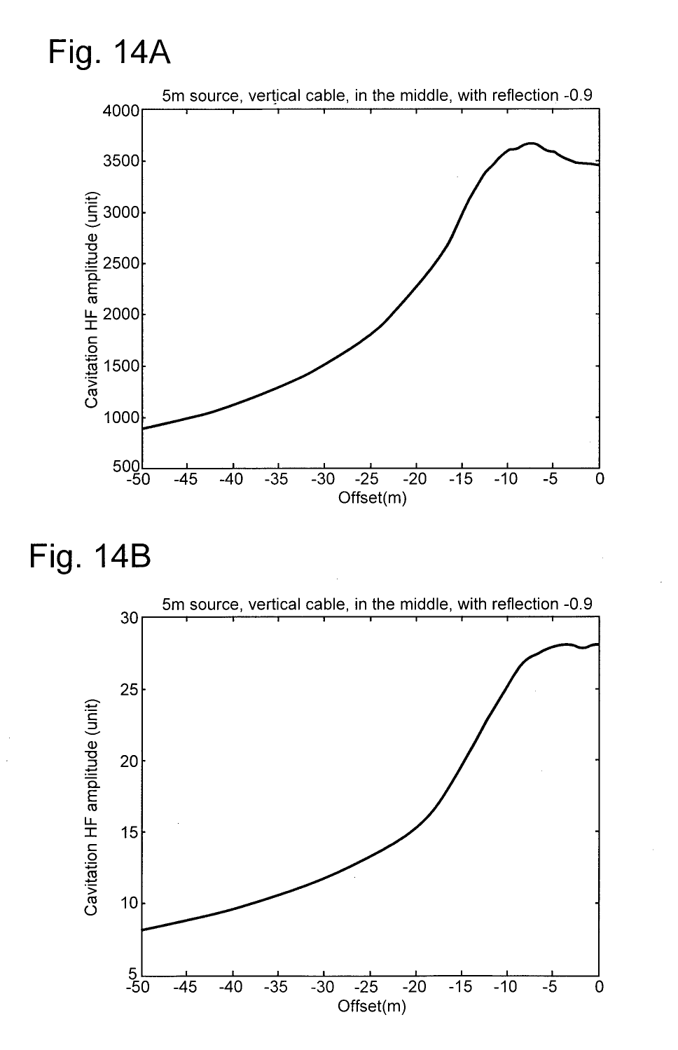

For example, if a conventional arrangement of a source 1300 including subarrays 1310, 1320 and 1330 having the same inline distances, zero attack angles and 6 m cross-interval between subarrays, is adjusted to increase the inline distance of subarray 1320 with 18 m as shown in FIG. 13B, the high-frequency components decrease over 100 times. Graph 14A is an image of estimated high frequency noise level measured on a line, 5 m beneath the source level, from the center of the source to 50 m on the STARBOARD (negative) direction, on which x-axis is the offset distance (0-50 m), y-axis is the high frequency level (in units). Graph 14B is similar to graph 14A and is related to source 1300 arranged as in FIG. 13B. The signature of source 1300 (i.e., seismic signals' energy profile far from the source) remains almost the same for the two arrangements in the low frequency (1 Hz-250 Hz) components, but the energy in the high-frequency (10 kHz-300 kHz) components is reduced from about 3500 units in FIG. 14A to about 25 units in FIG. 14B. The arrangement achieving substantial attenuation of the high-frequency components may be maintained throughout the survey or temporarily implemented when, for example, whales are present near (<10 km) the source, or during the night when whales' presence cannot be assessed.

The two objectives (maximum energy propagation in a predetermined direction and attenuation of the high-frequency components) may not be achievable simultaneously and by varying a single geometric parameter (among the inline distance, the attack angle and the cross-line position) of a subarray. However, improvements may be achieved relative to both objectives by varying a single geometric parameter of a subarray. Therefore, an arrangement meeting multiple objectives is preferentially determined by simulation, via a multi-parameter optimization.

Returning now to FIG. 12, method 1200 may further include monitoring the marine source during a marine survey exploring a structure under the seafloor. When the monitoring indicates that one of the air-guns malfunctions or when the predetermined direction changes according to a survey plan, method 1200 may include repeating the adjusting step.

As previously discussed, during step 1220, the inline distance may be adjusted by changing the umbilical cable's length, the attack angle may be adjusted by generating a momentum causing rotation of a longitudinal axis of the air-gun subarrays relative to the towing direction, and the cross-line position may be adjusted by generating a force perpendicular to the towing direction.

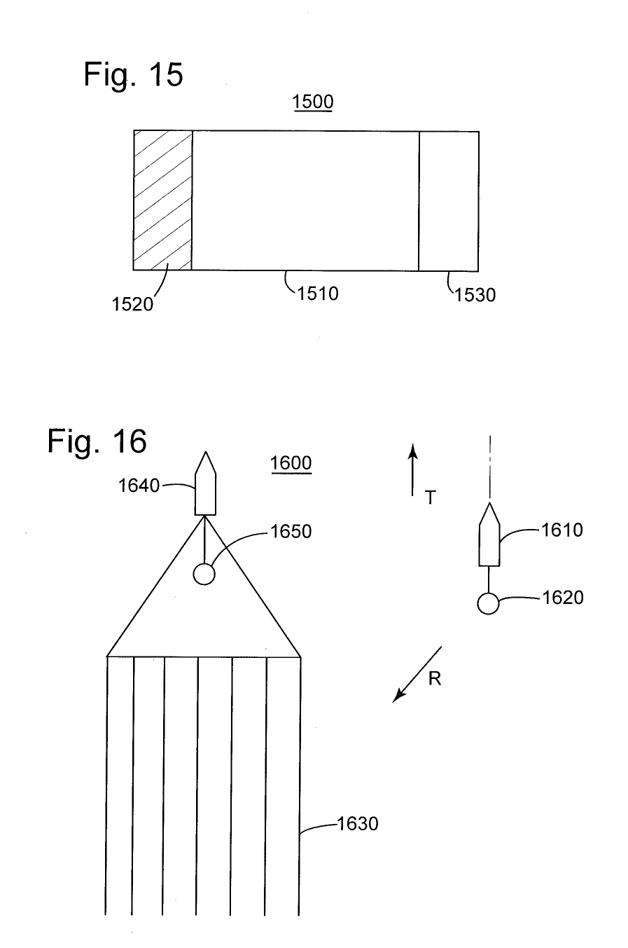

FIG. 15 illustrates a block diagram of a controller 1500 according to an embodiment. Hardware, firmware, software or a combination thereof may be employed by controller 1500 to perform the various steps and operations. Controller 1500 includes a data processing unit 1510 (having one or more data processors), coupled to an interface 1520 and a memory 1530.

Interface 1520 is configured to transmit commands (e.g., to deflectors or winches) for adjusting an inline distance, an attack angle and/or a cross-line position for at least one air-gun subarray, so that the seismic signals have a maximum energy emitted in a predetermined direction. Data processing unit 1510 is configured to generate these commands to achieve a subarray arrangement so that the seismic signals have a maximum energy emitted in a predetermined direction.

Data processing unit 1510 may also be configured to design the arrangement of the air-gun subarrays using simulations. Data processing unit 1510 may alternatively or additionally be configured to determine the arrangement based on measurements (received via interface 1520) of the seismic signals for different arrangements of the air-gun subarrays.

Memory 1530 may include a random access memory (RAM), a read-only memory (ROM), CD-ROM, removable media and any other forms of media capable of storing data. Memory 1530 may store various data related to the marine source characteristics, a survey plan. etc. Memory 1530 may also store executable codes which, when executed on a processor (e.g., by data processing unit 1510) make the processor perform method 1200.

FIG. 16 illustrates a marine seismic survey system 1600 according to an embodiment. System 1600 includes a vessel 1610 towing a marine source 1620 laterally relative to a streamer 1630 towed by another vessel 1640 (which may also tow another source 1650). Vessels 1610 and 1640 move in substantially the same direction T. Marine seismic source 1620 is configured to emit seismic signals whose maximum energy propagates in a predetermined direction. The projection of the predetermined direction in the water surface plane is illustrated by arrow R pointing toward streamer 1630. Marine seismic source 1620 may be any of the previously discussed embodiments.

The disclosed embodiments provide marine sources, methods and systems achieving better detection of reflected energy by arranging subarrays of a marine source. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for controlling geometry of towed air-gun subarrays, the method comprising:
deploying the air-gun subarrays in water, each of the air-gun subarrays having air-guns attached substantially along a longitudinal segment linked to a towing vessel via an umbilical cable; and
adjusting a geometric parameter for at least one of the air-gun subarrays, to change energy distribution of seismic signals generated by the subarrays.

2. The method of claim 1, wherein the energy distribution is changed so that an amount of energy propagating around a predetermined azimuth angle increases.

3. The method of claim 1, wherein the energy distribution is changed to attenuate components of the seismic signals having frequencies over 1 KHz.

4. The method of claim 1, wherein the adjusting is performed to achieve an arrangement of the air-gun subarrays that has been designed by simulation and/or has been determined based on measurements of the seismic signals for different arrangements of the air-gun subarrays.

5. The method of claim 1, further comprising:
monitoring the marine source during a marine survey exploring structure under the seafloor; and
repeating the adjusting when the monitoring indicates that one of the air-guns malfunctions.

6. The method of claim 1, further comprising:
repeating the adjusting when a survey configuration changes according to a survey plan.

7. The method of claim 1, wherein
the adjusted geometric parameter is an inline distance, which is a distance from a front end of the longitudinal segment to the towing vessel in a towing direction, and
the inline distance is adjusted by changing a length of the umbilical cable.

8. The method of claim 1, wherein
the adjusted geometric parameter is an attack angle, which is an angle between the longitudinal segment and the towing direction, and
the attack angle is adjusted by generating a momentum causing rotation of the longitudinal segment of the at least one of the air-gun subarrays in the water surface plane.

9. The method of claim 1, wherein
the adjusted geometric parameter is a cross-line position, which is defined as being a position on a line perpendicular to the towing path in a water surface plane, and
the cross-line position is adjusted by generating a force applied perpendicular to the longitudinal segment in the water surface plane, to cause a translation thereof.

10. A marine seismic source comprising:
air-gun subarrays, each of the air-gun subarrays having air-guns attached substantially along a longitudinal segment linked to a towing vessel via an umbilical cable; and
a controller configured to control geometry of the air-gun subarrays by changing a geometric parameter for at least one of the air-gun subarrays.

11. The source of claim 10, wherein the controller is configured to achieve a subarray arrangement yielding an energy distribution when the source is fired so that an amount of energy propagating in an azimuth-angle range including a predetermined azimuth angle is larger than an amount of energy propagating in any azimuth range having substantially equal size to the azimuth angle range but not including the predetermined azimuth angle.

12. The source of claim 10, wherein the controller is configured to achieve a subarray arrangement so that components of the seismic signals having frequencies over 1 KHz are attenuated.

13. The source of claim 10, wherein the controller determines an arrangement of the air-gun subarrays designed by simulation and/or determined based on measurements of the seismic signals for different arrangements of the air-gun subarrays.

14. The source of claim 10, wherein the controller is further configured:
to monitor the marine source during a marine survey exploring a structure under the seafloor; and
to cause new changes of the geometric parameter when one of the air-guns malfunctions.

15. The source of claim 10, wherein the controller is further configured to cause new changes of the geometric parameters when a survey configuration is changed according to a survey plan.

16. The source of claim 10, wherein
the geometric parameter includes an inline distance, which is a distance from a front end of the longitudinal segment to the towing vessel in a towing direction, and
the controller adjusts the inline distance by causing a change of a length of the umbilical cable.

17. The source of claim 10, wherein
the adjusted geometric parameter is an attack angle, which is an angle between the longitudinal segment and the towing direction, and
the controller adjusts the attack angle using a steering mechanism to generate a momentum perpendicular to the water surface plane, the momentum causing rotation of the longitudinal segment in the water surface plane.

18. The source of claim 10, wherein
the adjusted geometric parameter is a cross-line position, which is defined as being a position on a line perpendicular to the towing path in a water surface plane, and
the controller adjusts the cross-line position using a device generating a force perpendicular to the longitudinal segment which causes a translation thereof.

19. A seismic survey system, comprising:
a towing vessel;
one or more streamers carrying receivers; and
a marine seismic source including air-gun subarrays, each of the air-gun subarrays having air-guns attached substantially along a longitudinal segment linked to the towing vessel via an umbilical cable; and
a controller configured to control geometry of the marine seismic source by changing a geometric parameter for at least one of the air-gun subarrays.

20. The seismic survey system of claim 19, wherein the controller is further configured to cause new changes of the geometric parameter, when one of the air-guns malfunctions, and/or a survey configuration is changed according to a survey plan
